(19) United States
(12) Patent Application Publication
(10) Pub. No.: US 2026/0102898 A1
(43) Pub. Date: Apr. 16, 2026

(54) Hand Tools and Containers for the Same

(71) Applicant: Milwaukee Electric Tool Corporation, Brookfield, WI (US)

(72) Inventors: Anna G. Tracy, Delafield, WI (US); Kyle A. Ritz, Burlington, WI (US); Jedidiah J. Babinec, Milwaukee, WI (US)

(21) Appl. No.: 19/348,077

(22) Filed: Oct. 2, 2025

Related U.S. Application Data
(60) Provisional application No. 63/705,639, filed on Oct. 10, 2024.
(60) Provisional application No. 63/813,892, filed on May 29, 2025.

(51) Int. Cl. B25H 3/02; A45F 3/00; A45F 3/04; B25F 1/00

(52) U.S. Cl. CPC B25H 3/022; A45F 3/04; B25F 1/003; A45F 2003/001; A45F 2003/003

(57) ABSTRACT

Various hand tools, hammers, and containers for equipment and tools provided. The hand tools and hammers described herein provide a plurality of functions each within a single item. The containers described herein are configured to be carried by a user, such as on a back of a user, and optionally to be hung from a wall, such as a wall of a utility bucket.

### CROSS-REFERENCE TO RELATED PATENT APPLICATIONS

This application claims the benefit of and priority to U.S. Provisional Application No. 63/813,892, filed May 29, 2025, and U.S. Provisional Application No. 63/705,639, filed Oct. 10, 2024, each of which is incorporated herein by reference in its entirety.

### BACKGROUND OF THE INVENTION

The present invention relates generally to the field of hand tools. The present invention relates specifically to multi-function hand tools and containers for holding the same.

### SUMMARY OF THE INVENTION

Another embodiment of the invention relates to a backpack including a first panel defining a first surface and an opposing second surface, a first strap coupled to the second surface and configured to extend over a first shoulder of a user, a second strap coupled to the second surface and configured to extend over a second shoulder of a user, a first plurality of compartments coupled to the first surface, a second panel coupled to the first panel, a first aperture defined by the first panel, and a second aperture defined by the second panel. The second panel defines a third surface and an opposing fourth surface. The second panel actuates between an open and a closed position with respect to the first panel. The third surface and the first surface face towards each other when the second panel is in the closed position with respect to the first panel. The first aperture is configured to receive a first hook coupled to a first support wall. The second aperture is configured to receive a second hook coupled to one of the first support wall.

Another embodiment of the invention relates to hand tool including a first jaw defining a first interface surface, a first handle rigidly coupled to the first jaw, a second jaw defining a second interface surface, a second handle rigidly coupled to the second jaw, and a socket attachment. The second jaw is on an opposite side of a first axis from the first jaw. The first axis extends longitudinally along the hand tool. The first interface surface and the second interface surface are configured to collectively grasp an object. The second handle is pivotally coupled to the first handle such that the first jaw and first handle pivotally rotate about a second axis with respect to the second jaw and the second handle. At least a portion of the socket attachment is integrally molded with the first handle.

Another embodiment of the invention relates to a hand tool including a first jaw defining a first recess and a first interface surface, a first handle rigidly coupled to the first jaw, a second jaw defining a second recess and a second interface surface, a second handle rigidly coupled to the second jaw, and a nut driver. The second jaw is on an opposite side of a first axis from the first jaw. The first axis extends longitudinally along the hand tool. The first jaw and the second jaw actuate between a closed position and an open position. The first interface surface and the second interface surface are configured to collectively grasp an object. The second handle is pivotally coupled to the first handle such that the first jaw and first handle pivotally rotate about a second axis with respect to the second jaw and the second handle. When the first jaw and second jaw are in the closed position the first recess and second recess collectively define the nut driver. The nut driver includes a plurality of planar surfaces each of which facing towards a central point of the nut driver.

Another embodiment of the invention relates to a hand tool including a first jaw, a first handle fixed to the first jaw, a second jaw, a second handle fixed to the second jaw, and a socket attachment integrally molded with the first handle opposite the first jaw. The second jaw is on an opposite side of a first axis from the first jaw, the first axis extending longitudinally along the hand tool. The second handle is pivotally coupled to the first handle such that the first jaw and first handle pivotally rotate about a second axis with respect to the second jaw and the second handle.

In various embodiments, the socket attachment includes four planar surfaces facing outward and symmetrically arranged around the second handle, and a protrusion extending outward from one of the planar surfaces.

Another embodiment of the invention relates to a backpack including a first panel defining a first surface and a second surface, a first strap coupled to the first surface and configured to extend over a first shoulder of a user, a second strap coupled to the first surface and configured to extend over a second shoulder of a user, a first plurality of compartments coupled to the second surface, a second panel coupled to the first panel, the second panel defining a third surface and a fourth surface, a second plurality of compartments coupled to the fourth surface, a first aperture defined by the first panel, the first aperture configured to receive a first hook coupled to a first support wall, and a second aperture defined by the second panel, the second aperture configured to receive a second hook coupled to one of the first support wall or a second support wall extending from the first support wall. The second panel actuates between an open and a closed position with respect to the first panel, and the third surface and the first surface face towards each other when the second panel is in the closed position with respect to the first panel.

Another embodiment of the invention relates to a hand tool including a first jaw, a first handle fixed to the first jaw, a second jaw, a second handle fixed to the second jaw, and a nut driver fixed to the first handle opposite the first jaw. The second jaw is on an opposite side of a first axis from the first jaw, the first axis extending longitudinally along the hand tool. The second handle is pivotally coupled to the first handle such that the first jaw and first handle pivotally rotate about a second axis with respect to the second jaw and the second handle.

In various embodiments, the nut driver is integrally molded with the first handle.

Another embodiment of the invention relates to a hammer including a handle extending from a first end to a second end, a body coupled to the first end of the handle, the body having a striking surface, and a magnet fixed to the second end of the handle.

Another embodiment of the invention relates to a hand tool including a first jaw, the first jaw defining a first recess, a first handle fixed to the first jaw, a second jaw, the second jaw defining a second recess, and a second handle fixed to the second jaw. The second jaw is on an opposite side of a first axis from the first jaw, the first axis extending longitudinally along the hand tool. The second handle is pivotally coupled to the first handle such that the first jaw and first handle pivotally rotate about a second axis with respect to the second jaw and the second handle. The first jaw and the second jaw actuate between a closed position and an open position. When the first jaw and second jaw are in the closed position the first recess and second recess collectively define a nut driver.

In various embodiments, the nut driver defines a plurality of planar surface symmetrically arranged around the nut driver.

Another embodiment of the invention relates to a hammer including a handle extending from a first end to a second end, a body coupled to the first end of the handle, the body having a striking surface, and a socket attachment fixed to the second end of the handle.

In various embodiments, the socket attachment includes four planar surfaces symmetrically arranged around the handle, and a pin detent extending outward from one of the planar surfaces.

In various embodiments, the socket attachment is integrally molded with the handle.

Additional features and advantages will be set forth in the detailed description which follows, and will be readily apparent to those skilled in the art from the description or recognized by practicing the embodiments as described in the written description and/or shown in the accompany drawings. It is to be understood that both the foregoing general description and the following detailed description are exemplary.

The accompanying drawings are included to provide further understanding and are incorporated in and constitute a part of this specification. The drawings illustrate one or more embodiments and, together with the description, serve to explain principles and operation of the various embodiments. In addition, alternative exemplary embodiments relate to other features and combinations of features as may be generally recited in the claims.

### BRIEF DESCRIPTION OF THE DRAWINGS

This application will become more fully understood from the following detailed description, taken in conjunction with the accompanying figures, wherein like reference numerals refer to like elements in which:

FIG. 1 is a side view of a hand tool, according to an exemplary embodiment.

FIG. 2 is a perspective view of a portion of the hand tool of FIG. 1, according to an exemplary embodiment.

FIG. 3 is a perspective view of a backpack, according to an exemplary embodiment.

FIG. 4 is a perspective view of the backpack of FIG. 3, according to an exemplary embodiment.

FIG. 5 is a rear view of the backpack of FIG. 3, according to an exemplary embodiment.

FIG. 6 is a perspective view of a backpack, according to an exemplary embodiment.

FIG. 7 is a front view of a backpack, according to an exemplary embodiment.

FIG. 8 is a front view of the backpack of FIG. 7, according to an exemplary embodiment.

FIG. 9 is a rear view of the backpack of FIG. 7, according to an exemplary embodiment.

FIG. 10 is a front view of the backpack of FIG. 7, according to an exemplary embodiment.

FIG. 11 is a side view of a hand tool, according to an exemplary embodiment.

FIG. 12 is a perspective view of a portion of the hand tool of FIG. 11, according to an exemplary embodiment.

FIG. 13 is a perspective view of a hammer, according to an exemplary embodiment.

FIG. 14 is a side view of a hand tool, according to an exemplary embodiment.

FIG. 15 is a perspective view of a hammer, according to an exemplary embodiment.

FIG. 16 is a side view of a hand tool, according to another exemplary embodiment.

FIG. 17 is a side view of the hand tool of FIG. 16, according to an exemplary embodiment.

FIG. 18 is a side view of the hand tool of FIG. 16, according to an exemplary embodiment.

FIG. 19 is a side view of a hand tool, according to another exemplary embodiment.

FIG. 20 is a side view of the hand tool of FIG. 19, according to an exemplary embodiment.

FIG. 21 is a perspective view of a portion of the hand tool of FIG. 19, according to an exemplary embodiment.

FIG. 22 is a perspective view of a portion of the hand tool of FIG. 19, according to an exemplary embodiment.

FIG. 23 is a perspective view of a hand tool, according to another exemplary embodiment.

FIG. 24 is a top view of the hand tool of FIG. 23, according to an exemplary embodiment.

FIG. 25 is a side view of the hand tool of FIG. 23, according to an exemplary embodiment.

FIG. 26 is a perspective view of the hand tool of FIG. 23, according to an exemplary embodiment.

FIG. 27 is a perspective view of the hand tool of FIG. 23, according to an exemplary embodiment.

FIG. 28 is a cross-section view of a portion of the hand tool of FIG. 23, according to an exemplary embodiment.

FIG. 29 is a perspective view of a hand tool, according to another exemplary embodiment.

FIG. 30 is a side view of the hand tool of FIG. 29, according to an exemplary embodiment.

FIG. 31 is a cross-section view of a portion of the hand tool of FIG. 29, according to an exemplary embodiment.

FIG. 32 is a top view of the hand tool of FIG. 29, according to an exemplary embodiment.

FIG. 33 is a perspective view of a hand tool, according to another exemplary embodiment.

FIG. 34 is a perspective view of a portion of the hand tool of FIG. 33, according to an exemplary embodiment.

FIG. 35 is a perspective view of a portion of the hand tool of FIG. 33, according to an exemplary embodiment.

FIG. 36 is a perspective view of a portion of the hand tool of FIG. 33, according to an exemplary embodiment.

FIG. 37 is a perspective view of a hand tool, according to another exemplary embodiment.

FIG. 38 is a front view of the hand tool of FIG. 37, according to an exemplary embodiment.

FIG. 39 is a perspective view of a portion of the hand tool of FIG. 37, according to an exemplary embodiment.

FIG. 40 is a perspective view of an insert that can be used with the hand tool of FIG. 37, according to an exemplary embodiment.

### DETAILED DESCRIPTION

Referring generally to the figures, various embodiments of multi-functional hand tools and containers for holding the same are shown. Described herein as several hand tools that provide combinations of functionalities not previously provided. As a result, users can carry a single tool that provides two or more functionalities, thereby permitting users to more easily carry additional tools or equipment. Also described herein are containers for being transported via straps, such as on a back of a user, and that includes structure that facilitate coupling the containers to platforms for users, such as utility buckets.

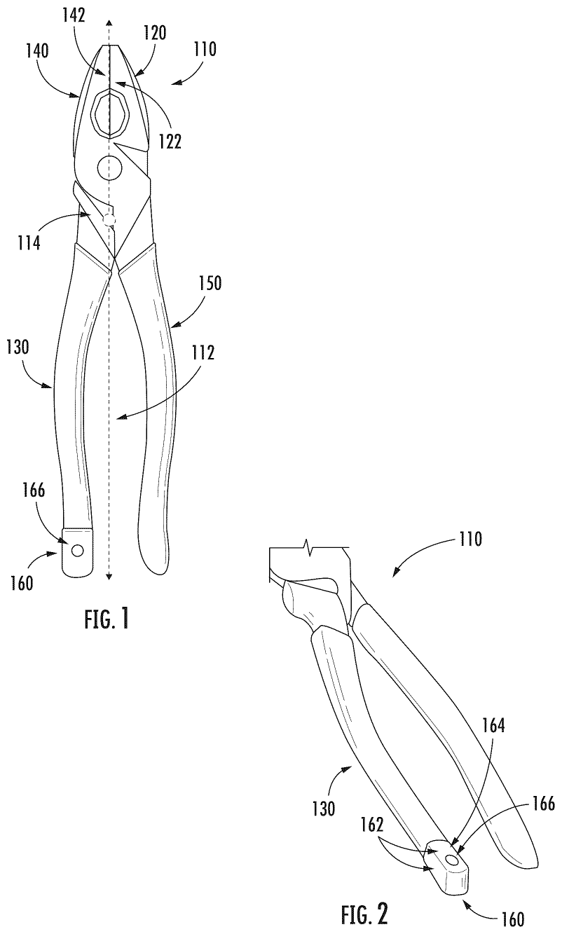

Referring to FIGS. 1-2 various aspects of hand tool 110 are provided. Hand tool 110 includes first jaw 120, first handle 130 rigidly coupled to first jaw 120, second jaw 140, second handle 150 rigidly coupled to second jaw 140, and socket attachment 160. First axis 112 extends along the longitudinal of hand tool 110. Second jaw 140 is on an opposite side of first axis 112 from first jaw 120, the first axis 112 extending longitudinally along the hand tool 110. First jaw 120 defines first interface surface 122, and second jaw 140 defines second interface surface 142. The first interface surface 122 and the second interface surface 142 are configured to collectively grasp an object.

Second handle 150 is pivotally coupled to first handle 130 such that first jaw 120 and first handle 130 pivotally rotate around second axis 114 with respect to second jaw 140 and second handle 150. In various embodiments, first jaw 120 and second jaw 140 actuate between a closed position, in which first jaw 120 and second jaw 140 are interfacing against each other, and an open position in which first jaw 120 and second jaw 140 are a non-zero distance apart. In various embodiments, the first axis 112 is perpendicular to the second axis 114. In various embodiments, the first interface surface 122 interfaces with the second interface surface 142 when the second jaw 140 is in a closed position with respect to the first jaw 120.

Socket attachment 160 is coupled to first handle 130 opposite first jaw 120. In various embodiments, at least a portion of socket attachment 160 is integrally molded with first handle 130, such as planar surfaces 162 being integrally molded with first handle 130. In various embodiments, the portion of the socket attachment 160 integrally molded with the first handle 130 is opposite the first jaw 120. In various embodiments, socket attachment 160 is coupled to an opposite end of first handle 130 from first jaw 120.

In various embodiments, socket attachment 160 includes a plurality of planar surfaces 162 facing outward and symmetrically arranged around first handle 130. In various embodiments, socket attachment 160 includes a projection, shown as pin detent 166, extending from a first planar surface 164 of planar surfaces 162. In various embodiments, socket attachment 160 includes a detent 166 that retractably extends, such as through first surface 164 of plurality of planar surfaces 162.

In a specific embodiment, socket attachment 160 includes four planar surfaces 162 facing outward and symmetrically arranged around first handle 130, and socket attachment 160 further includes a pin detent 166 extending outward from a first surface 164 of planar surfaces 162. In various embodiments, socket attachment 160 is sized to fit one or more sizes inclusively between 0.25″and 1″.

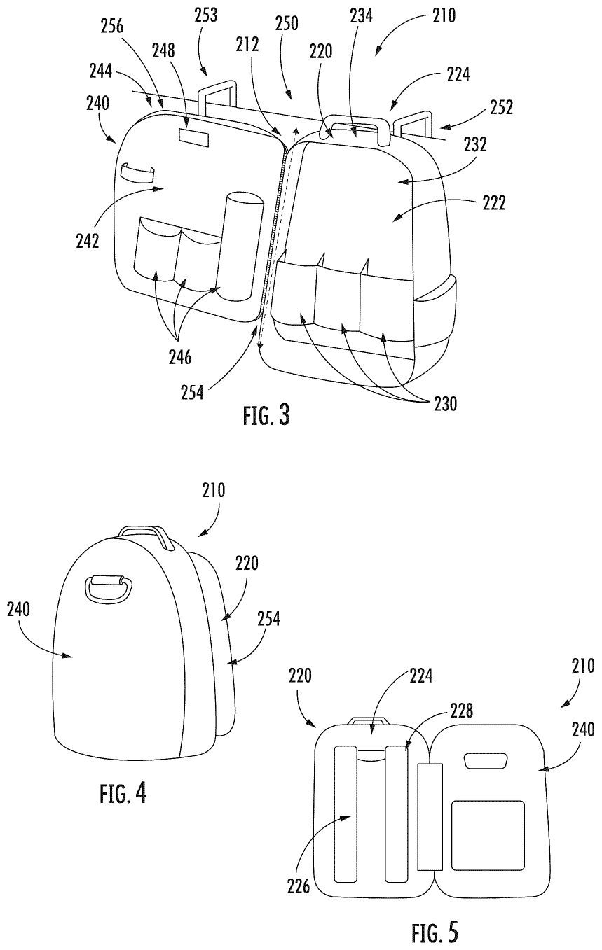

Referring to FIGS. 3-5, various aspects of backpack 210 are shown. Backpack 210 includes first panel 220 and second panel 240 coupled to first panel 220. In various embodiments first panel 220 and/or second panel 240 are boards that are mostly and/or entirely rigid. First panel 220 actuates between an open and closed position about axis 212 with respect to second panel 240. In various embodiments, backpack 210 includes first panel 220, first strap 226, second strap 228, a first plurality of compartments 230, a second panel 240 coupled to the first panel 220, a first aperture 232 defined by the first panel 220, and a second aperture 248 defined by the second panel 240.

First panel 220 defines first surface 222 and opposing second surface 224, which are on opposite sides of first panel 220 and facing away from each other. Second panel 240 defines third surface 242 and an opposing fourth surface 244, which are on opposite sides of second panel 240 and facing away from each other. Second panel 240 actuates between an open and a closed position with respect to the first panel 220, and third surface 242 and first surface 222 face towards each other when second panel 240 is in the closed position with respect to first panel 220.

In various embodiments, backpack 210 includes first strap 226 and second strap 228 coupled to second surface 224 of first panel 220. First strap 226 is coupled to second surface 224 and configured to extend over and around a first shoulder of a user carrying backpack 210, and second strap 228 is coupled to second surface 224 and configured to extend over and around a second shoulder of a user carrying backpack 210. In this way, backpack 210 can be easily carried by a user, such as when the utility bucket cannot access a location where the user wants to work so the user can then decouple backpack 210 from the utility bucket and carry backpack 210 on the back of the user. In various embodiments, backpack 210 includes a fastener, shown as zipper 254, coupled to the first panel 220 and the second panel 240, the zipper 254 configured to secure the second panel 240 in the closed position with respect to the first panel 220.

Backpack 210 includes a first plurality of compartments 230 coupled to first panel 220, such as to first surface 222 of first panel 220. Backpack 210 includes a second plurality of compartments 246 coupled to second panel 240, such as to third surface 242 of second panel 240. Compartments 230 and compartments 246 are configured to receive and carry various objects, such as equipment and/or tools. In various embodiments, each of the first plurality of compartments 230 opens up towards a first top 234 of the first panel 220, and each of the second plurality of compartments 246 opens up towards a second top 256 of the second panel 240. In various embodiments, the first aperture 232 is between the first top 234 and each of the first plurality of compartments 230. In various embodiments, the second aperture 248 is between the second top 256 and each of the second plurality of compartments 246.

First aperture 232 is defined by first panel 220, and first aperture 232 is configured to receive a first hook 252 coupled to a support wall, such as first wall 250. Second aperture 248 is defined by second panel 240, and second aperture 248 is configured to receive a second hook 253 coupled to one of the first support wall 250 or a second support wall extending from the first support wall 250. In various uses, first panel 220 is supported by a portion of wall 250 that is coplanar with the portion of wall 250 supporting second panel 240. Alternatively, first panel 220 is supported by a portion of wall 250 that extends at a non-zero angle (e.g., 90 degrees) with respect to portion of wall 250 supporting second panel 240. In various embodiments, backpack 210 includes first hook 252 and/or second hook 253.

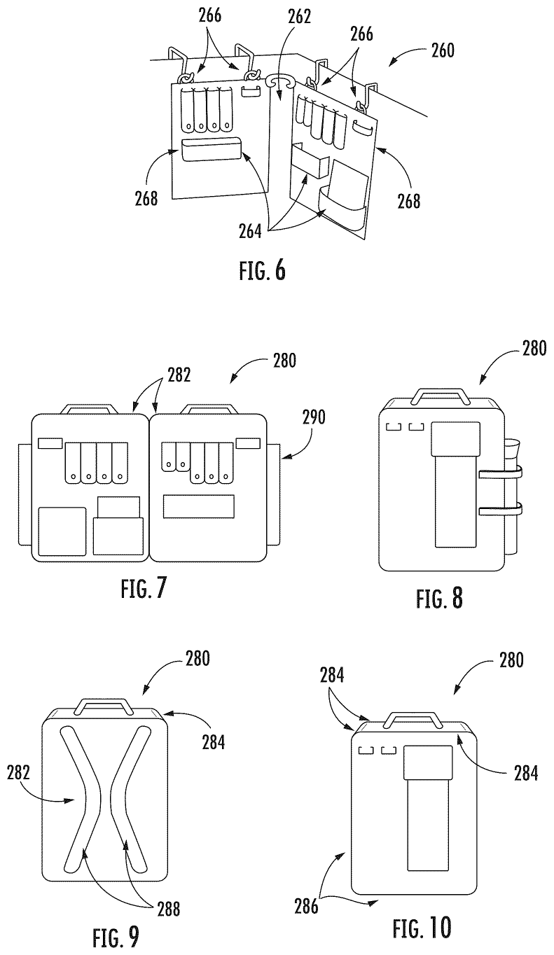

Referring to FIG. 6, various aspects of backpack 260 are shown. Backpack 260 is substantially the same as backpack 210 except for the differences discussed herein. Backpack 260 includes hinge 262 that pivotally couples panels 268. Each panel 268 includes one or more compartments 264 and one or more apertures 266 that receive a hook that support the panel 268 and therefore also backpack 260.

Referring to FIGS. 7-10, various aspects of backpack 280 are shown. Backpack 280 is substantially the same as backpack 210 or backpack 260 except for the differences discussed herein. Backpack 280 includes panels 282 pivotally coupled together. Panels 282 actuate between the closed position and the open position with respect to each other. Backpack 280 includes one or more straps 288 coupled to one or more of panels 282. In various embodiments, straps 288 are configured to facilitate a user carrying backpack 280.

Backpack 280 includes upper zipper 284 that extends around some or most of the upper portion of backpack 280, and upper zipper 284 can be configured in the engaged position when panels 282 are in the closed position, thereby enclosing area with panels 282. To access area within panels 282, a user can disengage upper zipper 284, thereby allowing a user to reach into the area with panels 282, such as to grab an object stored within backpack 280.

Backpack 280 includes lower zipper 286 that extends around some or most of the lateral portion of backpack 280 between panels 282, and optionally along the bottom portion of backpack 280. Lower zipper 286 can be configured in the engaged position when panels 282 are in the closed position, thereby enclosing area with panels 282. To actuate panels 282 into the open position, lower zipper 286 and/or upper zipper 284 can be disengaged, thereby permitting panels 282 to be actuated to the open position.

In various embodiments, backpack 280 includes pocket(s) 290 coupled to one of panels 282. Pocket(s) 290 optionally pivot and/or fold outside of panels 282 when backpack 280 is in the open position, thereby moving pockets 290 out of the way from the user accessing items within backpack 280.

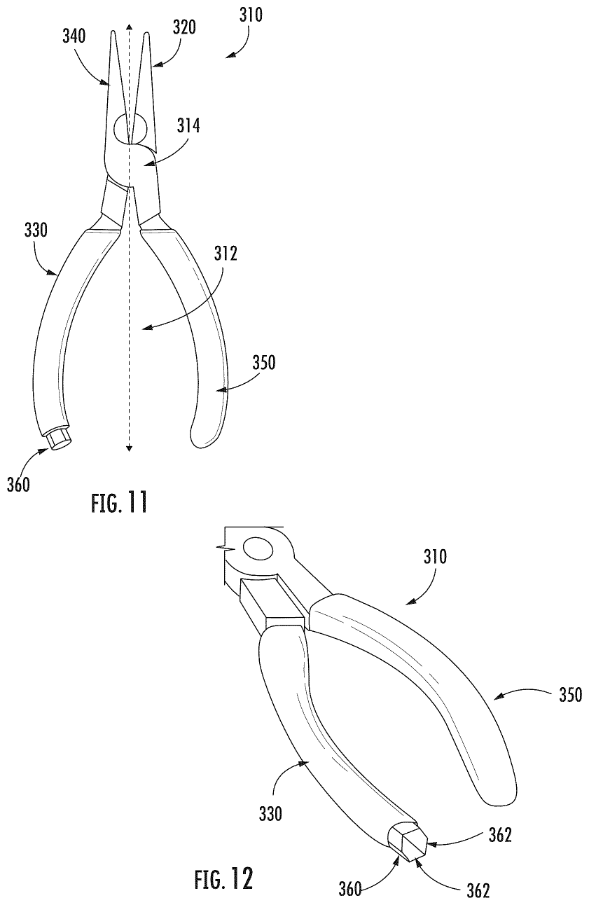

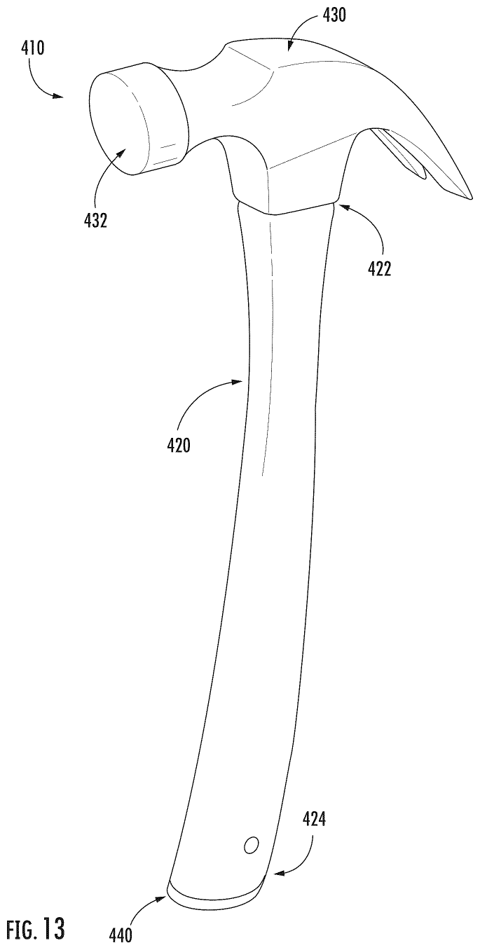

Referring to FIGS. 11-12 various aspects of hand tool 310 are provided. Hand tool 310 is substantially the same as hand tool 110 except for the differences discussed herein. In particular, hand tool 310 includes nut driver 360.

Hand tool 310 includes first jaw 320, first handle 330 fixed to first jaw 320, second jaw 340, second handle 350 fixed to second jaw 340, and nut driver 360. First axis 312 extends along the longitudinal of hand tool 310. Second jaw 340 is on an opposite side of first axis 312 from first jaw 320.

Second handle 350 is pivotally coupled to first handle 330 such that first jaw 320 and first handle 330 pivotally rotate around axis 314 with respect to second jaw 340 and second handle 350. In various embodiments, first jaw 320 and second jaw 340 actuate between a closed position, in which first jaw 320 and second jaw 340 are interfacing against each other, and an open position in which first jaw 320 and second jaw 340 are a non-zero distance apart.

In various embodiments, nut driver 360 is integrally molded with first handle 330 opposite first jaw 320. Thus, nut driver 360 is coupled to an opposite end of first handle 330 from first jaw 320. In various embodiments, nut driver 360 includes a plurality of planar surfaces 362 facing inward and symmetrically arranged within nut driver 360. In various embodiments, nut driver 360 is sized to fit a 0.25″bit.

Referring to FIG. 13 various aspects of hammer 410 are provided. Hammer 410 includes handle 420 extending from first end 422 to second end 424, body 430 coupled to first end 422 of handle 420, body 430 having a striking surface 432, and magnet 440 fixed to second end 424 of handle 420.

Striking surface 432 is configured to be struck against objects (e.g., nails) thereby transferring the momentum of hammer 410 into the struck object. Magnet 440 is configured to facilitate the user picking up magnetically responsive objects, such as nails. In this way, if the user drops a nail when attempting to affix the nail into an object, the user can more easily pick up the nail by placing magnet 440 near the nail, at which point the nail will be magnetically coupled to magnet 440 and the user can more easily retrieve the nail to once again attempt to affix the nail into the object.

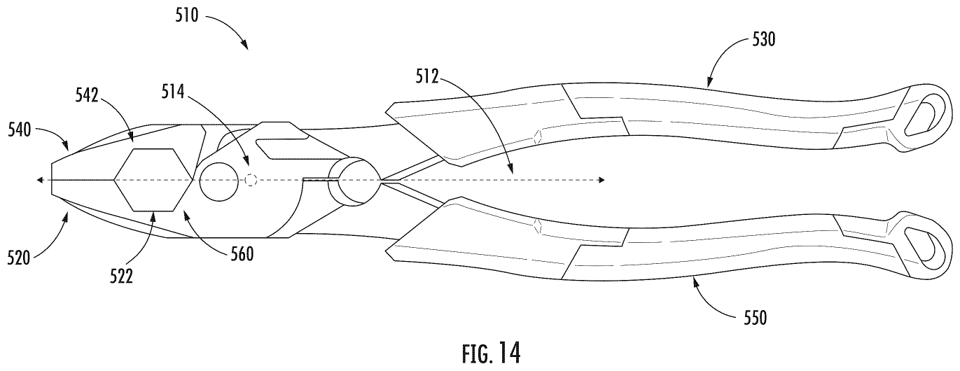

Referring to FIG. 14 various aspects of hand tool 510 are provided. Hand tool 510 is substantially the same as hand tool 110 or hand tool 310 except for the differences discussed herein. In particular, hand tool 510 includes nut driver 560.

Hand tool 510 includes first jaw 520, first handle 530 rigidly coupled to first jaw 520, second jaw 540, second handle 550 rigidly coupled to second jaw 540, and nut driver 560. First axis 512 extends along the longitudinal of hand tool 510. Second jaw 540 is on an opposite side of first axis 512 from first jaw 520. First jaw 520 defines first recess 522 and first interface surface 532. Second jaw 540 defines second recess 542 and second interface surface 544. In various embodiments, the first interface surface 532 interfaces with the second interface surface 544 when the second jaw 540 is in a closed position with respect to the first jaw 520.

Second handle 550 is pivotally coupled to first handle 530 such that first jaw 520 and first handle 530 pivotally rotate around second axis 514 with respect to second jaw 540 and second handle 550. In various embodiments, first jaw 520 and second jaw 540 actuate between a closed position, in which first jaw 520 and second jaw 540 are interfacing against each other, and an open position in which first jaw 520 and second jaw 540 are a non-zero distance apart. Stated another way, first jaw 520 and the second jaw 540 actuate between a closed position and an open position, and the first interface surface 532 and the second interface surface 552 are configured to collectively grasp an object.

First jaw 520 includes first recess 522, and second jaw 540 includes second recess 542. When first jaw 520 and second jaw 540 are in the closed position with respect to each other, first recess 522 and second recess 542 collectively define nut driver 560. In various embodiments, nut driver 560 includes a plurality of planar surfaces 562 facing inward and symmetrically arranged within nut driver 560. In various embodiments, nut driver 560 includes a plurality of planar surfaces 562 each of which facing towards a central point 564 of the nut driver 560. In various embodiments, each of the plurality of planar surfaces 562 are parallel to the second axis 514. In various embodiments, nut driver 560 is between the second axis 514 and each of the first interface surface 532 and the second interface surface 552 when the first jaw 520 and the second jaw 540 are in the closed position.

In various embodiments, nut driver 560 includes a varying size, such as a 6 point size at a certain depth and a 12 point size at a different depth. In this way, nut driver 560 is configured to be used with and fit with two or more different sizes.

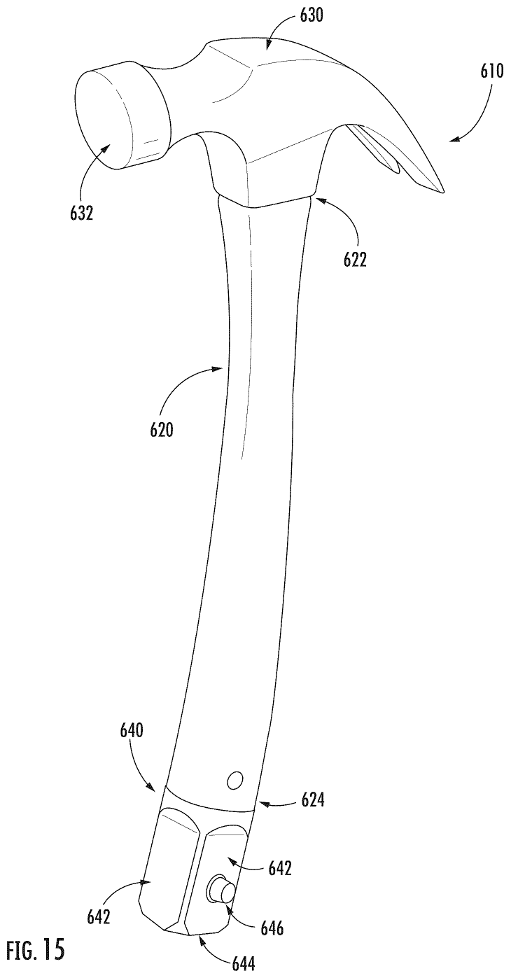

Referring to FIG. 15 various aspects of hammer 610 are provided. Hammer 610 is substantially the same as hammer 410 except for the differences discussed herein. In particular, hammer 610 includes socket attachment 640.

Hammer 610 includes handle 620 extending from first end 622 to second end 624, body 630 coupled to first end 622 of handle 620, body 630 having a striking surface 632, and socket attachment 640 fixed to second end 624 of handle 620. Striking surface 632 is configured struck against objects (e.g., nails) thereby transferring the momentum of hammer 610 into the struck object.

In various embodiments, socket attachment 640 is integrally molded with handle 620 opposite body 630. In various embodiments, socket attachment 640 includes a plurality of planar surfaces 642 facing outward and symmetrically arranged around handle 620. In various embodiments, socket attachment 640 includes a projection, shown as pin detent 646, extending from a first planar surface 644 of planar surfaces 642.

In a specific embodiment, socket attachment 640 includes four planar surfaces 642 facing outward and symmetrically arranged around first handle 620, and socket attachment 640 further includes a pin detent 646 extending outward from a first surface 644 of planar surfaces 642.

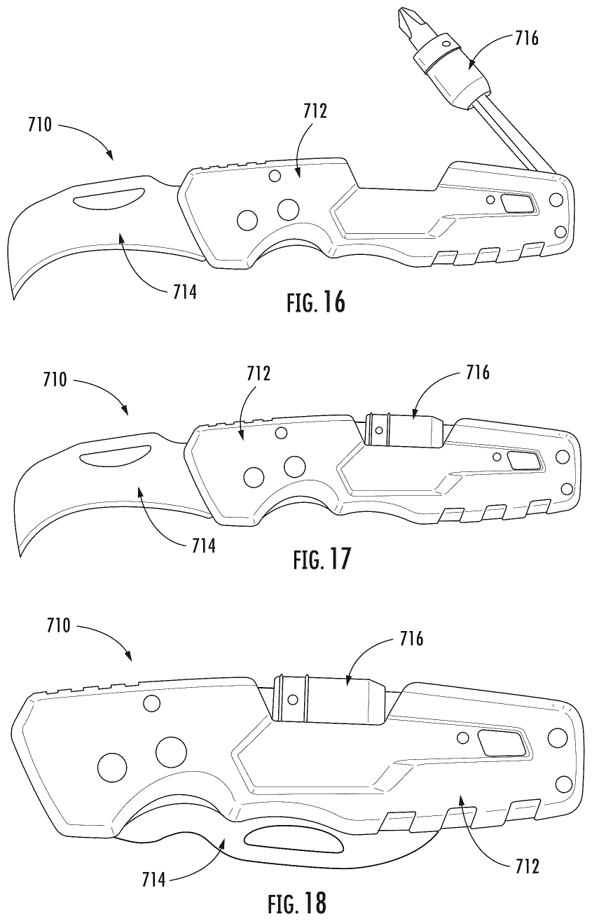

Referring to FIGS. 16-18, various aspects of hand tool 710 are provided. Hand tool 710 is substantially the same as hand tool 110 except for the differences discussed herein.

Hand tool 710 includes handle 712, blade 714 pivotally coupled to handle 712, and screwdriver 716 pivotally coupled to handle 712. Each of blade 714 and screwdriver 716 actuate between being extended from handle 712 (see FIG. 16) and retracted within handle 712 (see FIG. 18). In various embodiments, blade 714 is a Blunt or Shark Hawkbill style blade.

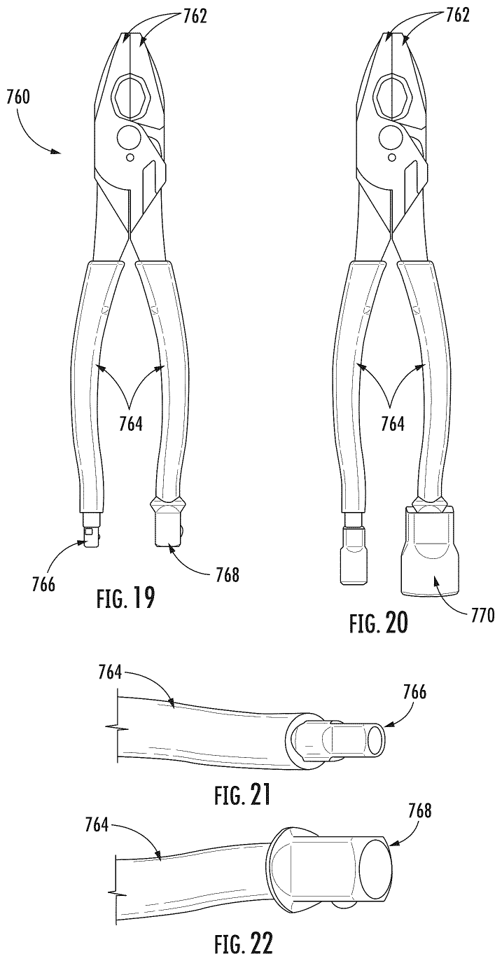

Referring to FIGS. 19-22, various aspects of hand tool 760 are provided. Hand tool 760 is substantially the same as hand tool 110, hand tool 310, or hand tool 510 except for the differences discussed herein.

Hand tool 760 includes handles 764 pivotally coupled to each other, and jaws 762 rigidly coupled to handles 764. First drive anvil 766 is coupled to one of handles 764, such as at least a portion of first drive anvil 766 being integrally molded with one of handles 764, and second drive anvil 768 is coupled to one of handles 764, such as at least a portion of second drive anvil 768 being integrally molded with one of handles 764. In various embodiments, each of first drive anvil 766 and second drive anvil 768 are square drive anvils. In various embodiments, each of first drive anvil 766 and second drive anvil 768 are configured to couple to sockets, such as socket 770. In various embodiments, first drive anvil 766 and second drive anvil 768 are different sizes (e.g., ½″, ¼″).

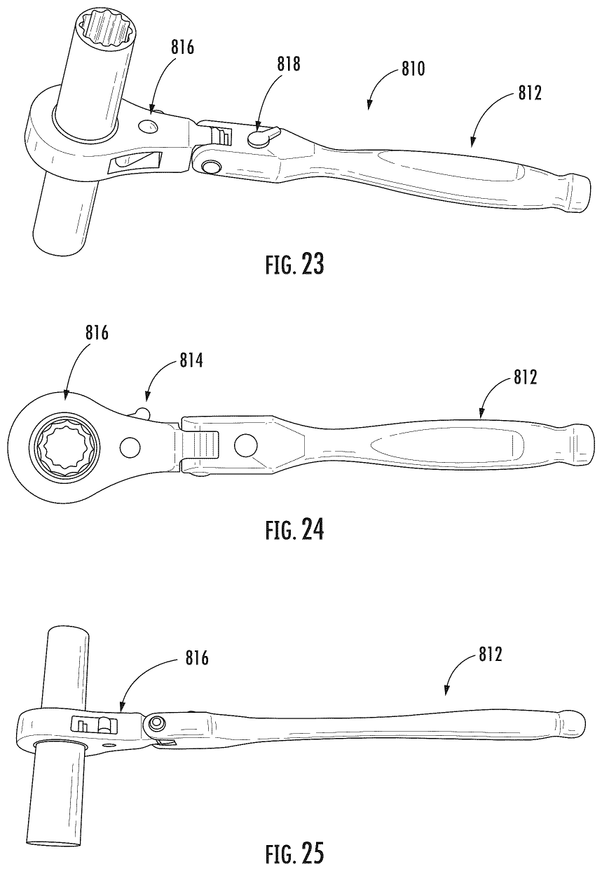

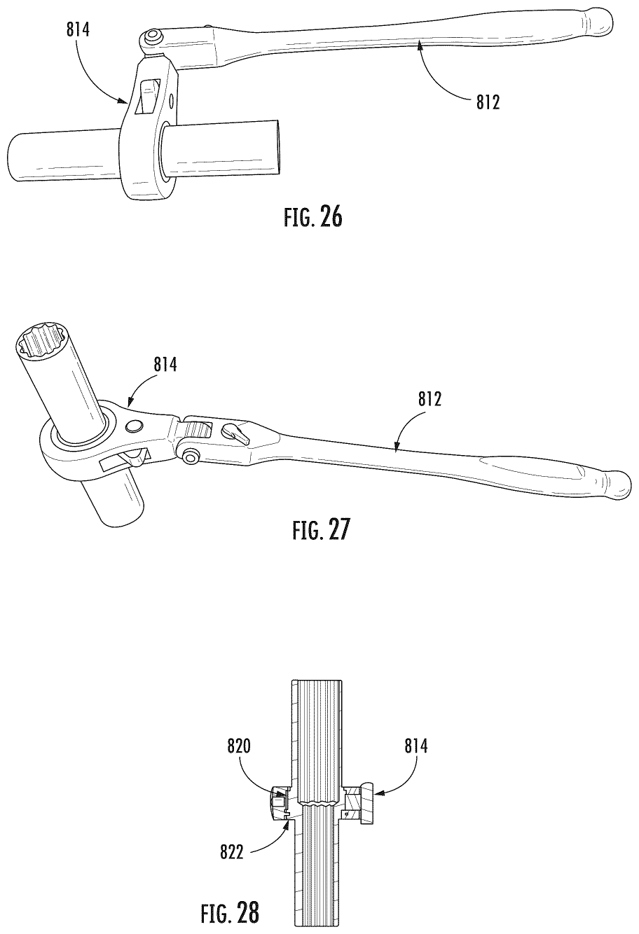

Referring to FIGS. 23-28, various aspects of hand tool 810 are provided. Hand tool 810 is substantially the same as hand tool 110, hand tool 310, hand tool 510, or hand tool 710 except for the differences discussed herein.

Hand tool 810 includes handle 812 and head 816 pivotally coupled to handle 812. Head lock 818 actuates between fixing the configuration of head 816 with respect to handle 812, and permitting head 816 to rotate with respect to handle 812. Selector 814 actuates the direction of rotation that first socket 820 or second socket 822 will facilitate a user rotating another socket (e.g., selector determines which rotational direction first socket 820 and second socket 822 will force rotation of another socket and which rotational direction that first socket 820 and second socket 822 will not force rotation of another socket). In various embodiments, first socket 820 and second socket 822 are different sizes (e.g., 9/16″, ¾″).

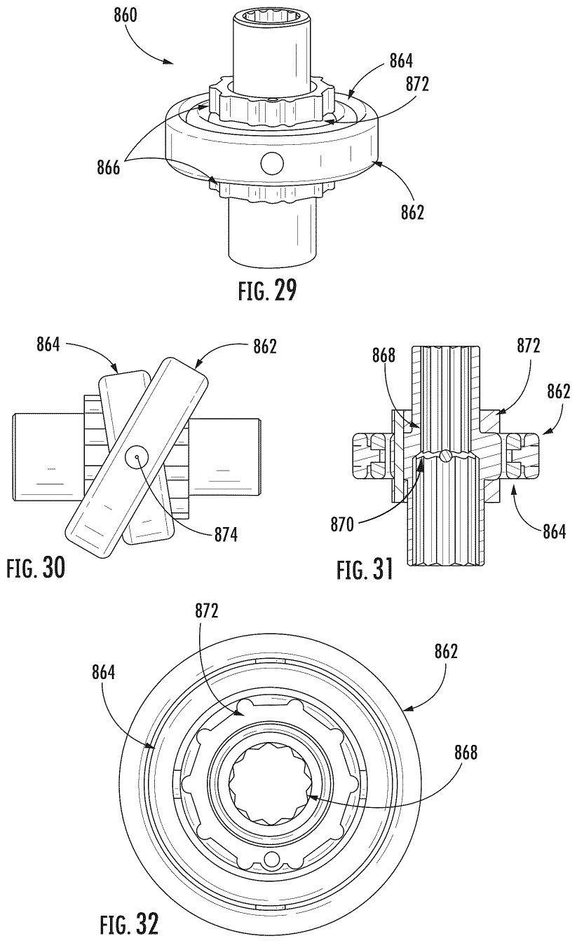

Referring to FIGS. 29-32, various aspects of hand tool 860 are provided. Hand tool 860 is substantially the same as hand tool 110, hand tool 310, hand tool 510, hand tool 710, hand tool 760 except for the differences discussed herein.

Hand tool 860 includes first ring 862, second ring 864, and head 872. Each of first ring 862, second ring 864, and head 872 rotate about axis 874 with respect to each other. Selector 866 actuates the direction of rotation that first socket 868 and second socket 870 will facilitate a user rotating another socket. In various embodiments, first socket 868 and second socket 870 are different sizes (e.g., 9/16″, ¾″).

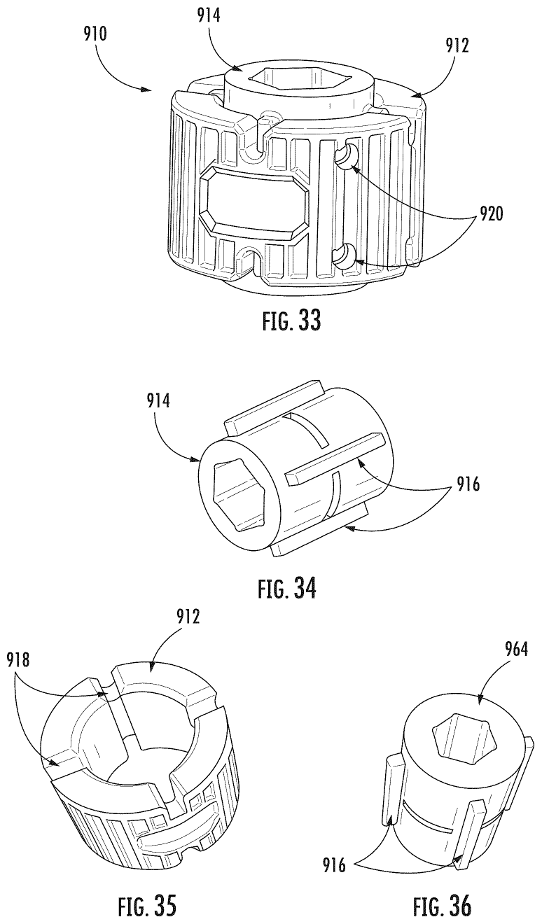

Referring to FIGS. 33-36, various aspects of hand tool 910 are provided. Hand tool 910 is substantially the same as hand tool 110, hand tool 310, hand tool 510, hand tool 710, hand tool 760, hand tool 810, or hand tool 860 except for the differences discussed herein.

Hand tool 910 includes handle 912 and insert 914 detachably coupled to handle 912. Insert 914 includes one or more ridges 916 that are received within recesses 918 of handle 912. Insert 914 is configured to couple to and rotate a fastener, such as a bolt, screw, or nut. The interface between ridges 916 and recesses 918 facilitates a user rotating handle 912 and thus insert 914, to thereby rotate the fastener. Hand tool 910 includes detent 920 to facilitate securing insert 914 within handle 912. In various embodiments, insert 914 includes two different sized sockets (e.g., 9/16″, ¾″).

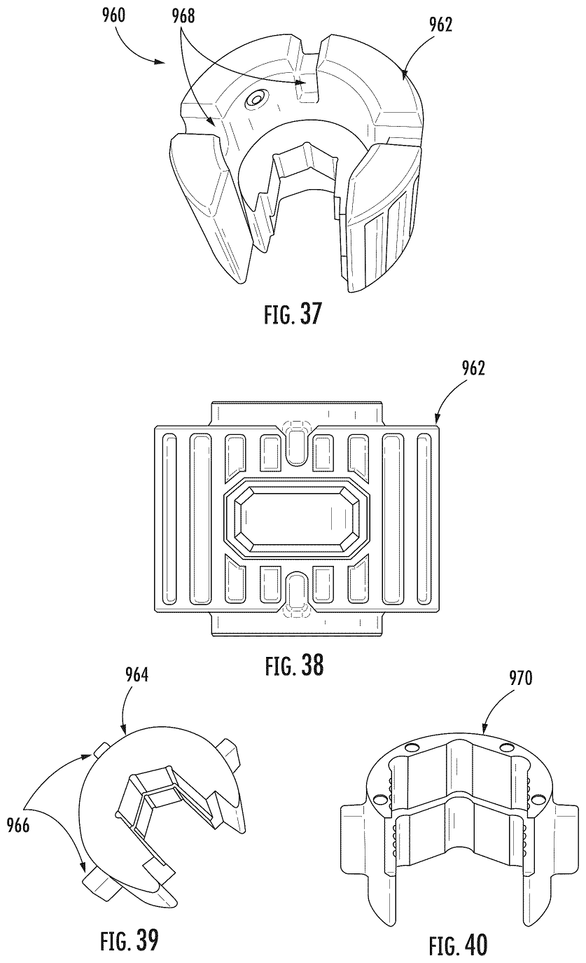

Referring to FIGS. 37-40, various aspects of hand tool 960 are provided. Hand tool 960 is substantially the same as hand tool 910 except for the differences discussed herein.

Hand tool 960 includes handle 962 and insert 964 detachably coupled to handle 962. Insert 964 includes one or more ridges 966 that are received within recesses 968 of handle 962. Insert 964 is configured to couple to and rotate a fastener, such as a bolt, screw, or nut. The interface between ridges 966 and recesses 968 facilitates a user rotating handle 962 and thus insert 964, to thereby rotate the fastener.

In various embodiments, handle tool 960 further includes insert 970. In various embodiments, insert 964 and insert 970 each include two different sized sockets (e.g., ½″, 9/16″, ⅝″, ¾″).

It should be understood that the figures illustrate the exemplary embodiments in detail, and it should be understood that the present application is not limited to the details or methodology set forth in the description or illustrated in the figures. It should also be understood that the terminology is for the purpose of description only and should not be regarded as limiting.

Further modifications and alternative embodiments of various aspects of the disclosure will be apparent to those skilled in the art in view of this description. Accordingly, this description is to be construed as illustrative only. The construction and arrangements, shown in the various exemplary embodiments, are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. Some elements shown as integrally formed may be constructed of multiple parts or elements, the position of elements may be reversed or otherwise varied, and the nature or number of discrete elements or positions may be altered or varied. The order or sequence of any process, logical algorithm, or method steps may be varied or re-sequenced according to alternative embodiments. Other substitutions, modifications, changes and omissions may also be made in the design, operating conditions and arrangement of the various exemplary embodiments without departing from the scope of the present disclosure.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that any particular order be inferred. In addition, as used herein, the article “a” is intended to include one or more component or element, and is not intended to be construed as meaning only one.

For purposes of this disclosure, the term “coupled” means the joining of two components directly or indirectly to one another. Such joining may be stationary in nature or movable in nature. Such joining may be achieved with the two members and any additional intermediate members being integrally formed as a single unitary body with one another or with the two members or the two members and any additional member being attached to one another. Such joining may be permanent in nature or alternatively may be removable or releasable in nature. As used herein, “rigidly coupled” refers to two components being coupled in a manner such that the components move together in a fixed positional relationship when acted upon by a force.

While the current application recites particular combinations of features in the claims appended hereto, various embodiments of the invention relate to any combination of any of the features described herein whether or not such combination is currently claimed, and any such combination of features may be claimed in this or future applications. Any of the features, elements, or components of any of the exemplary embodiments discussed above may be used alone or in combination with any of the features, elements, or components of any of the other embodiments discussed above.

In various exemplary embodiments, the relative dimensions, including angles, lengths and radii, as shown in the Figures are to scale. Actual measurements of the Figures will disclose relative dimensions, angles and proportions of the various exemplary embodiments. Various exemplary embodiments extend to various ranges around the absolute and relative dimensions, angles and proportions that may be determined from the Figures. Various exemplary embodiments include any combination of one or more relative dimensions or angles that may be determined from the Figures. Further, actual dimensions not expressly set out in this description can be determined by using the ratios of dimensions measured in the Figures in combination with the express dimensions set out in this description.

What is claimed is:

1. A backpack comprising:
a first panel defining a first surface and an opposing second surface;
a first strap coupled to the second surface and configured to extend over a first shoulder of a user;
a second strap coupled to the second surface and configured to extend over a second shoulder of a user;
a first plurality of compartments coupled to the first surface;
a second panel coupled to the first panel, the second panel defining a third surface and an opposing fourth surface, wherein the second panel actuates between an open and a closed position with respect to the first panel, wherein the third surface and the first surface face towards each other when the second panel is in the closed position with respect to the first panel;
a first aperture defined by the first panel, the first aperture configured to receive a first hook coupled to a first support wall; and
a second aperture defined by the second panel, the second aperture configured to receive a second hook coupled to one of the first support wall.

2. The backpack of claim 1, comprising the first hook.

3. The backpack of claim 2, comprising the second hook.

4. The backpack of claim 1, comprising a second plurality of compartments coupled to the third surface.

5. The backpack of claim 1, comprising a fastener coupled to the first panel and the second panel, the fastener configured to secure the second panel in the closed position with respect to the first panel.

6. The backpack of claim 1, wherein each of the first plurality of compartments opens up towards a first top of the first panel.

7. The backpack of claim 6, wherein the first aperture is between the first top and each of the first plurality of compartments.

8. The backpack of claim 7, comprising a second plurality of compartments coupled to the third surface, wherein each of the second plurality of compartments opens up towards a second top of the second panel, and wherein the second aperture is between the second top and each of the second plurality of compartments.

9. A hand tool comprising:
a first jaw defining a first interface surface;
a first handle rigidly coupled to the first jaw;
a second jaw defining a second interface surface, the second jaw is on an opposite side of a first axis from the first jaw, the first axis extending longitudinally along the hand tool, wherein the first interface surface and the second interface surface are configured to collectively grasp an object;
a second handle rigidly coupled to the second jaw, wherein the second handle is pivotally coupled to the first handle such that the first jaw and first handle pivotally rotate about a second axis with respect to the second jaw and the second handle; and
a socket attachment, wherein at least a portion of the socket attachment is integrally molded with the first handle.

10. The hand tool of claim 9, wherein the portion of the socket attachment integrally molded with the first handle is opposite the first jaw.

11. The hand tool of claim 9, wherein the first axis is perpendicular to the second axis.

12. The hand tool of claim 9, wherein the first interface surface interfaces with the second interface surface when the second jaw is in a closed position with respect to the first jaw.

13. The hand tool of claim 9, the socket attachment comprising a detent that retractably extends.

14. The hand tool of claim 9, the socket attachment comprising a plurality of planar surfaces.

15. The hand tool of claim 14, wherein the plurality of planar surfaces are symmetrically arranged around the first handle.

16. The hand tool of claim 15, the socket attachment comprising a detent that retractably extends from a first planar surface of the plurality of planar surfaces.

17. A hand tool comprising:
a first jaw defining a first recess and a first interface surface;
a first handle rigidly coupled to the first jaw;
a second jaw defining a second recess and a second interface surface, wherein the second jaw is on an opposite side of a first axis from the first jaw, the first axis extending longitudinally along the hand tool, the first jaw and the second jaw actuating between a closed position and an open position, wherein the first interface surface and the second interface surface are configured to collectively grasp an object;
a second handle rigidly coupled to the second jaw, wherein the second handle is pivotally coupled to the first handle such that the first jaw and first handle pivotally rotate about a second axis with respect to the second jaw and the second handle; and
a nut driver, wherein when the first jaw and second jaw are in the closed position the first recess and second recess collectively define the nut driver, the nut driver comprising a plurality of planar surfaces each of which facing towards a central point of the nut driver.

18. The hand tool of claim 17, wherein the first interface surface interfaces with the second interface surface when the second jaw is in a closed position with respect to the first jaw.

19. The hand tool of claim 17, wherein each of the plurality of planar surfaces are parallel to the second axis.

20. The hand tool of claim 17, wherein the nut driver is between the second axis and each of the first interface surface and the second interface surface when the first jaw and the second jaw are in the closed position.
